(19) United States
(12) Patent Application Publication
(10) Pub. No.: US 2026/0341961 A1
(43) Pub. Date: Oct. 29, 2026

(54) CROSSED DIPOLE ANTENNA AND MANUFACTURING METHOD THEREOF

(71) Applicant: ARCADYAN TECHNOLOGY CORPORATION, Hsinchu City (TW)

(72) Inventor: Pao-De HUANG, Taoyuan City (TW)

(73) Assignee: ARCADYAN TECHNOLOGY CORPORATION, Hsinchu City (TW)

(21) Appl. No.: 19/630,098

(22) Filed: Mar. 26, 2026

(30) Foreign Application Priority Data
Apr. 23, 2025 (TW) 114115349
Jan. 16, 2026 (TW) 115101873

(51) Int. Cl. H01Q 5/48; H01Q 5/307; H01Q 25/00

(52) U.S. Cl. CPC H01Q 5/48; H01Q 5/307; H01Q 25/001

(57) ABSTRACT

A crossed dipole antenna includes: a circuit board, a first antenna, a second antenna, a first feed line, and a second feed line. The first antenna is arranged on the circuit board, and includes a first radiator and a second radiator which are linearly arranged. The second antenna is arranged on the circuit board and is orthogonal to the first antenna at an angle of 90 degrees. The second antenna includes a third radiator and a fourth radiator which are linearly arranged. The first feed line is electrically connected to the first radiator and the second radiator. The second feed line is arranged across the first feed line, and is electrically connected to the third radiator and the fourth radiator.

### CROSS-REFERENCE TO RELATED APPLICATIONS

This application claims the benefit of priority to Taiwanese Patent Application No. 114115349, filed Apr. 23, 2025, and Taiwanese Patent Application No. 115101873, filed Jan. 16, 2026, the entire disclosures of which are incorporated herein by reference.

### BACKGROUND OF THE DISCLOSURE

### Technical Field

The present disclosure relates to an antenna, and especially relates to a crossed dipole antenna which is implemented using a printed circuit board.

### Description of Related Art

With the development of the technology, the size of various electronic apparatuses has become smaller, and thus the available space for the antenna arrangement in these electronic apparatuses has been compressed.

The commonly known crossed dipole antennas are typically three-dimensional in shape, and are made by stamping and bending the metal sheets. Therefore, the overall area of the antenna after production is relatively large and occupies considerable space, such that they are more suitable for the outdoor equipment, as they are three-dimensional and large in size, making them unsuitable for use in the electronic apparatuses with the reduced volumes.

Therefore, the market needs to develop the new antennas which are smaller in size, suitable for these compact electronic apparatuses, yet still capable of supporting the required frequency bands. Additionally, in order to balance the miniaturization, high efficiency, and dual polarization characteristics within the limited space, the dual feed antennas are expected to become a growing trend in the future antenna.

### SUMMARY OF THE INVENTION

The present disclosure provides a crossed dipole antenna, which includes: a circuit board, a first antenna, a second antenna, a first feed line, and a second feed line. The first antenna is arranged on the circuit board. The first antenna includes a first radiator and a second radiator which are linearly arranged. The second antenna is arranged on the circuit board, and is orthogonal to the first antenna at an angle of 90 degrees. The second antenna includes a third radiator and a fourth radiator which are linearly arranged. The first feed line is electrically connected to the first radiator and the second radiator. The second feed line is arranged across the first feed line, and is electrically connected to the third radiator and the fourth radiator.

The present disclosure further provides a manufacturing method for a crossed dipole antenna. The manufacturing method includes following steps. A circuit board is provided. A first antenna and a second antenna are formed on the circuit board, wherein the first antenna includes a first radiator and a second radiator which are linearly arranged, and the second antenna includes a third radiator and a fourth radiator which are linearly arranged, and the first antenna and the second antenna are arranged orthogonally at a 90-degree angle on the circuit board. Then, a first feed line is provided. The first feed line is soldered to the first antenna, and is electrically connected to the first radiator and the second radiator to form a first signal feeding point. Finally, a second feed line is provided. The second feed line is soldered to the second antenna, and is electrically connected to the third radiator and the fourth radiator to form a second signal feeding point, wherein the first feed line and the second feed line are arranged across each other.

### BRIEF DESCRIPTION OF THE DRAWINGS

FIG. 1 shows a schematic appearance diagram of a crossed dipole antenna according to an embodiment of the present disclosure.

FIG. 2A shows a schematic appearance diagram of the circuit board of the crossed dipole antenna of FIG. 1.

FIG. 2B shows a partially enlarged schematic diagram of a first radiator of FIG. 2A.

FIG. 3 shows a schematic side view showing the circuit board of the crossed dipole antenna of FIG. 2A after being electrically connected to a first feed line and a second feed line.

FIG. 4 shows a schematic appearance diagram of the crossed dipole antenna according to another embodiment of the present disclosure.

FIG. 5 shows a schematic appearance diagram of the circuit board of the crossed dipole antenna of FIG. 4.

FIG. 6 shows a schematic diagram showing the electrical connection between the circuit board of the crossed dipole antenna of FIG. 5 and the first feed line and the second feed line.

FIG. 7 shows a schematic flowchart illustrating the manufacturing process of the crossed dipole antenna according to the present disclosure.

FIG. 8 shows a schematic diagram showing the crossed dipole return loss according to the present disclosure.

FIG. 9 shows a schematic diagram showing the crossed dipole isolation level according to the present disclosure.

FIG. 10 shows a schematic diagram showing the efficiency of the crossed dipole antenna according to the present disclosure.

FIG. 11 shows a schematic appearance diagram of a crossed dipole antenna according to yet another embodiment of the present disclosure.

FIG. 12 shows a schematic appearance diagram of the circuit board of the crossed dipole antenna of FIG. 11.

FIG. 13 shows a schematic side view showing the circuit board of the crossed dipole antenna of FIG. 11 after being electrically connected to a first feed line and a second feed line.

FIG. 14 shows a schematic appearance diagram of the circuit board of the crossed dipole antenna according to still another embodiment of the present disclosure.

### DETAILED DESCRIPTION

The technical contents and the detailed descriptions of the present application are now explained in conjunction with the accompanying drawings as follows:

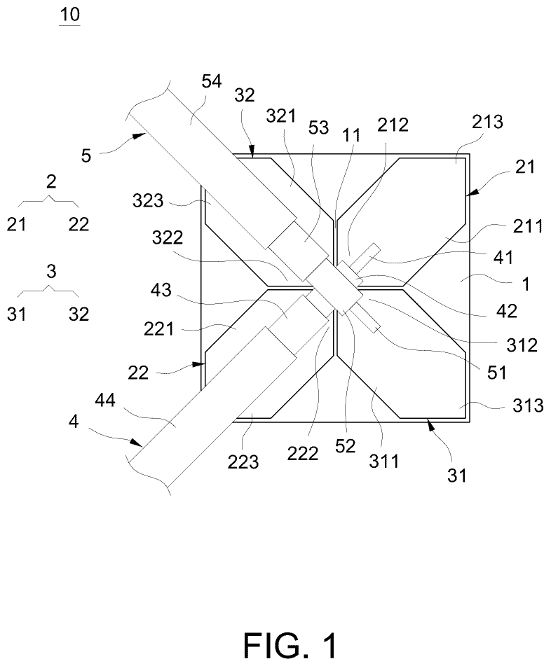

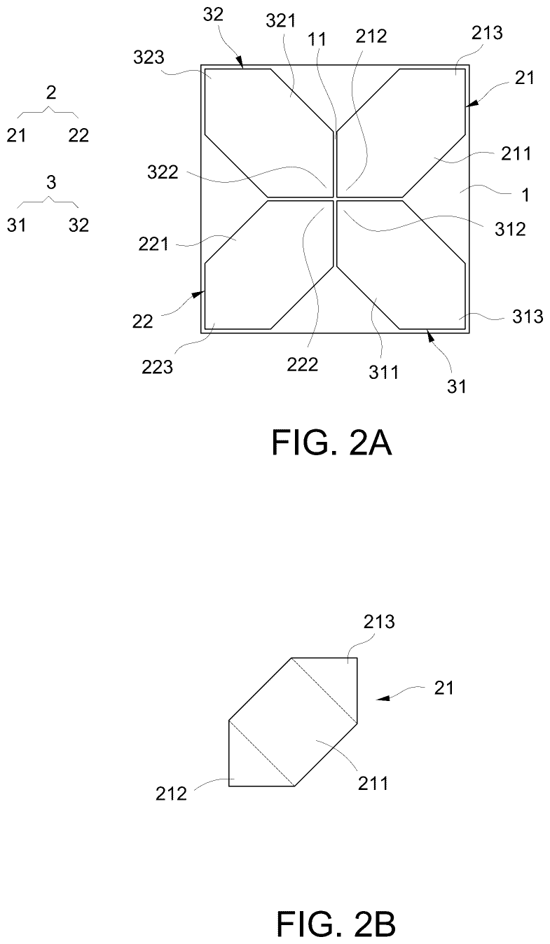

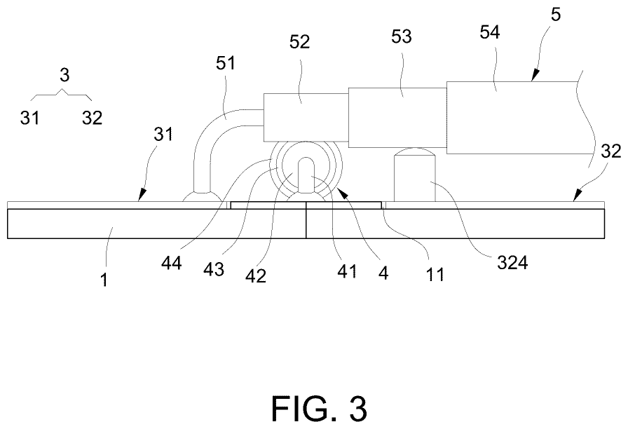

FIG. 1 shows a schematic appearance diagram of a crossed dipole antenna according to an embodiment of the present disclosure. FIG. 2A shows a schematic appearance diagram of the circuit board of the crossed dipole antenna of FIG. 1. FIG. 2B shows a partially enlarged schematic diagram of a first radiator of FIG. 2A. FIG. 3 shows a schematic side view showing the circuit board of the crossed dipole antenna of FIG. 2A after being electrically connected to a first feed line and a second feed line. Please refer to FIG. 1 to FIG. 3. As shown in FIG. 1, the crossed dipole antenna 10 of the present disclosure includes a circuit board 1, a first antenna 2, a second antenna 3, a first feed line 4, and a second feed line 5, wherein the first antenna 2 and the second antenna 3 are arranged on the same side of the circuit board 1, and the first antenna 2 and the second antenna 3 are electrically connected to the first feed line 4 and the second feed line 5 respectively, so as to form the crossed dipole antenna 10. In the drawings, the circuit board 1 is a printed circuit board.

As shown in the above FIG. 1, FIG. 2A, and FIG. 2B, the first antenna 2 is arranged on one side of the circuit board 1. The first antenna 2 includes a first radiator 21 and a second radiator 22 which are linearly arranged. The shapes of the first radiator 21 and the second radiator 22 may, for example, be the shapes shown in FIG. 2B. In one embodiment, each of the first radiator 21 and the second radiator 22 includes a polygonal body 211, 221. Each of the polygonal bodies 211, 221 extends at two ends respectively with an inner triangular body 212, 222 and an outer triangular body 213, 223 which are symmetrical to each other. In the drawings, the first antenna 2 is a copper foil material arranged on the circuit board 1.

As further shown in the above FIG. 1, FIG. 2A, and FIG. 2B, the second antenna 3 is arranged on the circuit board 1, and is orthogonal to the first antenna 2 at an angle of 90 degrees on the same side. Similarly, the second antenna 3 includes a third radiator 31 and a fourth radiator 32 which are linearly arranged. The shapes of the third radiator 31 and the fourth radiator 32 may, for example, be the shapes shown in FIG. 2B. In one embodiment, each of the third radiator 31 and the fourth radiator 32 includes a polygonal body 311, 321. Each of the polygonal bodies 311, 321 extends at two ends respectively with an inner triangular body 312, 322 and an outer triangular body 313, 323 which are symmetrical to each other. In the drawings, the second antenna 3 is a copper foil material arranged on the circuit board 1.

As further shown in the above FIG. 2A, a coupling gap 11 is between the inner triangular bodies 212, 222, 312, 322 of the first radiator 21, the second radiator 22, the third radiator 31, and the fourth radiator 32 respectively. This coupling gap 11 is used to adjust the bandwidth and the performance of the first antenna 2 and the second antenna 3. In one embodiment, the coupling gap is between 0.1 mm to 0.5 mm.

The first feed line 4 and the second feed line 5 mentioned above may be made of the same type of the wire materials. As shown in the above FIG. 1, each of the first feed line 4 and the second feed line 5 includes a central conductor 41, 51, an insulating layer 42, 52, an outer conducting layer 43, 53, and a covering layer 44, 54. A surface of the central conductor 41, 51 is covered with the insulating layer 42, 52. A surface of the insulating layer 42, 52 is covered with the outer conducting layer 43, 53. A surface of the outer conducting layer 43, 53 is covered with the covering layer 44, 54.

Similarly, as shown in the above FIG. 1, the central conductor 41 of the first feed line 4 is electrically connected to the inner triangular body 212 of the first radiator 21, and the outer conducting layer 43 of the first feed line 4 is electrically connected to the inner triangular body 222 of the second radiator 22, to form a first signal feeding point. Moreover, the central conductor 51 of the second feed line 5 is electrically connected to the inner triangular body 312 of the third radiator 31, and the outer conducting layer 53 of the second feed line 5 is electrically connected to the inner triangular body 322 of the fourth radiator 32, to form a second signal feeding point.

It is worth mentioning that in the embodiment disclosed in FIG. 1, the first antenna 2 and the second antenna 3 are arranged on the same side of the circuit board 1. When the first antenna 2 and the second antenna 3 are arranged on the same side of the circuit board 1, as shown in FIG. 3, when the second feed line 5 is electrically connected to the second antenna 3, a spacer 324 of the crossed dipole antenna 10 may first be arranged on the inner triangular body 322 of the fourth radiator 32. In this embodiment, the insulating layer 52 of the second feed line 5 is arranged across the insulating layer 42 of the first feed line 4, such that the outer conducting layer 53 of the second feed line 5 is electrically connected to the spacer 324 to be electrically connected to the fourth radiator 32 through the spacer 324, to form the second signal feeding point. The spacer 324 of the present disclosure elevates the second feed line 5 and electrically connects the second feed line 5 to the fourth radiator 32 of the second antenna 3. The main function of the spacer 324 mentioned above is to increase the distance between the second antenna 3 and the signal surface, improving the antenna isolation level. In one embodiment, the spacer 324 is a tin-based solder ball. In one embodiment, a height of the spacer 324 is between 0.5 mm and 1.5 mm.

It is further worth mentioning that a length ratio of the central conductor 41, 51, the insulating layer 42, 52, and the outer conducting layer 43, 53 of each of the first feed line 4 and the second feed line 5 of the present disclosure is 1:0.7:2. By adopting the above length ratio, the first feed line 4 and the second feed line 5 are matched with the crossed dipole antenna 10, thereby preventing the signal and gain attenuation during the signal transmission and reception.

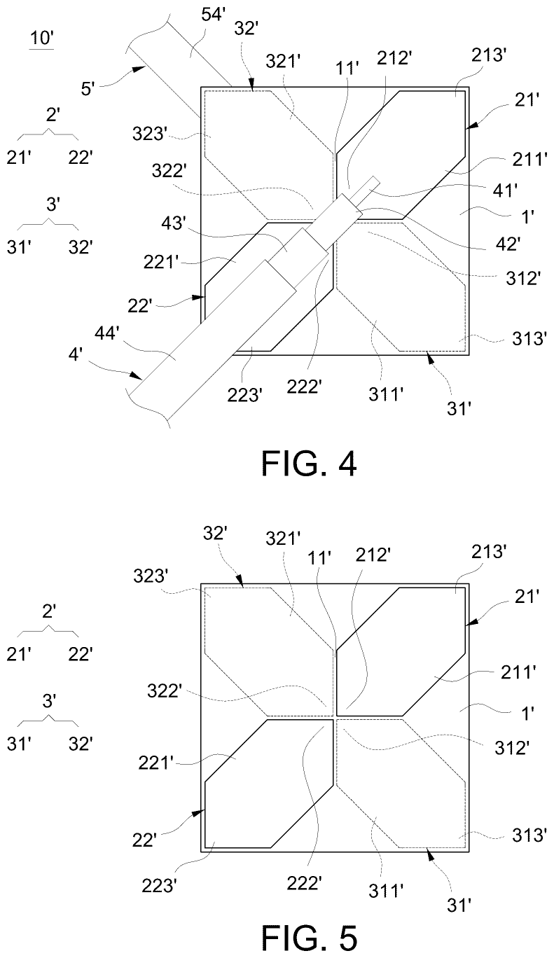

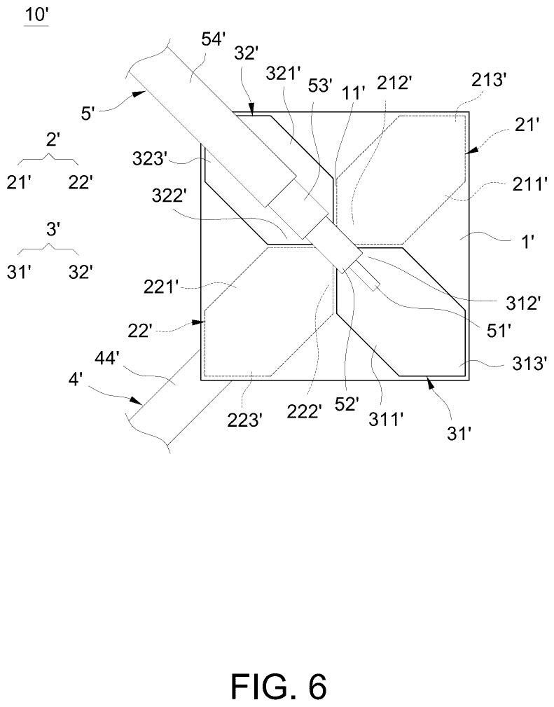

FIG. 4 shows a schematic appearance diagram of the crossed dipole antenna according to another embodiment of the present disclosure. FIG. 5 shows a schematic appearance diagram of the circuit board of the crossed dipole antenna of FIG. 4. FIG. 6 shows a schematic diagram showing the electrical connection between the circuit board of the crossed dipole antenna of FIG. 5 and the first feed line and the second feed line. Please refer to FIG. 4 to FIG. 6. The crossed dipole antenna 10′ of another embodiment of FIG. 4 to FIG. 6 of the present disclosure is substantially the same as the crossed dipole antenna 10 of the embodiment of the above FIG. 1 to FIG. 3, except that in another embodiment, the first antenna 2′ and the second antenna 3′ of the crossed dipole antenna 10′ are arranged on different sides of the circuit board 1′. Specifically, the first antenna 2′ is arranged on one side of the circuit board 1′, and the second antenna 3′ is arranged on the other side of the circuit board 1′, and the first antenna 2′ is electrically connected to the first feed line 4′, and the second antenna 3′ is electrically connected to the second feed line 5′, and the first antenna 2′ and the second antenna 3′ form a 90-degree orthogonal angle on different sides of the circuit board 1′.

As shown in the above FIG. 4 and FIG. 5, in this embodiment, the first antenna 2′ includes a first radiator 21′ and a second radiator 22′ which are linearly arranged. The second antenna 3′ also includes a third radiator 31′ and a fourth radiator 32′ which are linearly arranged. The shapes of the first radiator 21′, the second radiator 22′, the third radiator 31′, and the fourth radiator 32′ may, for example, be the shapes shown in FIG. 2B. Each of the first radiator 21′, the second radiator 22′, the third radiator 31′, and the fourth radiator 32′ includes a polygonal body 211′, 221′, 311′, 321′, respectively. Each of the polygonal bodies 211′, 221′, 311′, 321′ extends at two ends respectively with an inner triangular body 212′, 222′, 312′, 322′ and an outer triangular body 213′, 223′, 313′, 323′ which are symmetrical to each other. In the drawings, the first antenna 2′ and the second antenna 3′ are copper foil materials arranged on the circuit board 1′.

As further shown in the above FIG. 5, when the first radiator 21′ and the second radiator 22′ are arranged on one side of the circuit board 1′ (shown as the solid lines in FIG. 4) and the third radiator 31′ and the fourth radiator 32′ are arranged on the other side of the circuit board 1′ (shown as the dashed lines in FIG. 4), a coupling gap 11′ is similarly between the inner triangular bodies 212′, 222′, 312′, 322′ of the first radiator 21′, the second radiator 22′, the third radiator 31′, and the fourth radiator 32′, respectively. This coupling gap 11′ is used to adjust the bandwidth and the performance of the first antenna 2′ and the second antenna 3′. In one embodiment, the coupling gap is between 0.1 mm and 0.5 mm.

Then, as shown in the above FIG. 4 and FIG. 6, when the first feed line 4′ is electrically connected to one side of the circuit board 1′ and the second feed line 5′ is electrically connected to the other side of the circuit board 1′, the first feed line 4′ is electrically connected to the first radiator 21′ and the second radiator 22′ on the one side of the circuit board 1′, and the second feed line 5′ is electrically connected to the third radiator 31′ and the fourth radiator 32′ on the other side of the circuit board 1′.

Then, as shown in the above FIG. 4 and FIG. 6, the central conductor 41′ of the first feed line 4′ is electrically connected to the inner triangular body 212′ of the first radiator 21′, and the outer conducting layer 43′ of the first feed line 4′ is electrically connected to the inner triangular body 222′ of the second radiator 22′, so as to form a first signal feeding point (as shown in FIG. 4). In addition, the central conductor 51′ of the second feed line 5′ is electrically connected to the inner triangular body 312′ of the third radiator 31′, and the outer conducting layer 53′ of the second feed line 5′ is electrically connected to the inner triangular body 322′ of the fourth radiator 32′, so as to form a second signal feeding point (as shown in FIG. 6). The difference from the crossed dipole antenna 10 disclosed in FIG. 1 to FIG. 3 is that, since the first antenna 2′ and the second antenna 3′ are arranged on different sides of the circuit board 1′ respectively, the first feed line 4′ and the second feed line 5′ do not overlap when the first feed line 4′ is electrically connected to the first antenna 2′ and the second feed line 5′ is electrically connected to the second antenna 3′. Therefore, in the crossed dipole antenna 10′ of the embodiment of FIG. 4 to FIG. 6, it is not necessary to arrange the aforementioned spacer 324 on the inner triangular body 322′ of the fourth radiator 32′.

It is worth mentioning that, in the embodiment of FIG. 4 and FIG. 6, a length ratio of the central conductor 41′, 51′, the insulating layer 42′, 52′, and the outer conducting layer 43′, 53′ of each of the first feed line 4′ and the second feed line 5′ may be 1:0.7:2. Therefore, the first feed line 4′ and the second feed line 5′ are matched with the crossed dipole antenna 10′ of FIG. 4 to FIG. 6, thereby preventing the signal and gain attenuation during the signal transmission and reception.

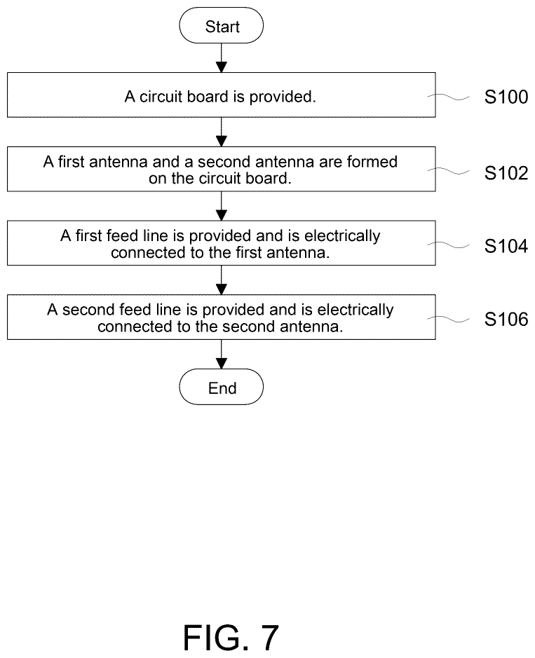

FIG. 7 shows a schematic flowchart illustrating the manufacturing process of the crossed dipole antenna according to the present disclosure. Please refer to FIG. 7. Meanwhile, please refer to FIG. 1 to FIG. 6. As shown in the drawings, the manufacturing method for the crossed dipole antennas 10, 10′ of the present disclosure includes the following specific steps. For ease of understanding, the following description takes the manufacturing of the crossed dipole antenna 10 of the embodiment of FIG. 1 to FIG. 3 as an example; however, it is also applicable to the manufacturing of the crossed dipole antenna 10′ of the embodiment of FIG. 4 to FIG. 6.

Step S100: A circuit board 1 is provided. A layer of copper foil is provided on one side or two sides of the circuit board 1.

Step S102: A first antenna 2 and a second antenna 3 are formed on the circuit board 1 by etching technology.

Specifically, in Step S102, a first antenna 2 and a second antenna 3 may be formed on one side of the circuit board 1 (applicable to the crossed dipole antenna 10), or a first antenna 2 is formed on one side of the circuit board 1 and the second antenna 3 is formed on the other side of the circuit board 1 (applicable to the crossed dipole antenna 10′). Moreover, the first antenna 2 includes a first radiator 21 and a second radiator 22 which are linearly arranged. The second antenna 3 includes a third radiator 31 and a fourth radiator 32 which are linearly arranged. The first antenna 2 and the second antenna 3 are orthogonally arranged at a 90-degree angle, whether the first antenna 2 and the second antenna 3 are arranged on one side or two sides of the circuit board 1. Each of the first radiator 21, the second radiator 22, the third radiator 31, and the fourth radiator 32 includes a polygonal body 211, 221, 311, 321, respectively. Each of the polygonal bodies 211, 221, 311, 321 extends at two ends respectively with an inner triangular body 212, 222, 312, 322 and an outer triangular body 213, 223, 313, 323 which are symmetrical to each other.

It is worth mentioning that, in Step S102, when the first radiator 21, the second radiator 22, the third radiator 31, and the fourth radiator 32 are formed, a coupling gap 11 is between the inner triangular bodies 212, 222, 312, 322 of the first radiator 21, the second radiator 22, the third radiator 31, and the fourth radiator 32, respectively. This coupling gap 11 is used to adjust the bandwidth and the performance of the first antenna 2 and the second antenna 3. Moreover, in the embodiment where the first antenna 2′ and the second antenna 3′ are arranged on different sides of the circuit board 1′, when the first radiator 21′, the second radiator 22′, the third radiator 31′, and the fourth radiator 32′ are formed in Step S102, a coupling gap 11′ is similarly between the inner triangular bodies 212′, 222′, 312′, 322′ of the first radiator 21′, the second radiator 22′, the third radiator 31′, and the fourth radiator 32′, respectively. In one embodiment, the coupling gap is between 0.1 mm and 0.5 mm.

Step S104: A first feed line 4 is provided and is electrically connected to the first antenna 2. The first feed line 4 includes a central conductor 41. A surface of the central conductor 41 is covered with an insulating layer 42. A surface of the insulating layer 42 is covered with an outer conducting layer 43. A surface of the outer conducting layer 43 is covered with a covering layer 44. In this step, the central conductor 41 of the first feed line 4 is electrically connected to the inner triangular body 212 of the first radiator 21, and the outer conducting layer 43 of the first feed line 4 is electrically connected to the inner triangular body 222 of the second radiator 22, so as to form a first signal feeding point.

Step S106: A second feed line 5 is further provided and is electrically connected to the second antenna 3. The second feed line 5 similarly includes a central conductor 51. A surface of the central conductor 51 is covered with an insulating layer 52. A surface of the insulating layer 52 is covered with an outer conducting layer 53. A surface of the outer conducting layer 53 is further covered with a covering layer 54.

If the first antenna 2′ and the second antenna 3′ are arranged on different sides of the circuit board 1, then in Step S106, the central conductor 51′ of the second feed line 5′ is electrically connected to the inner triangular body 312′ of the third radiator 31′, and the outer conducting layer 53′ of the second feed line 5′ is electrically connected to the inner triangular body 322′ of the fourth radiator 32′, thereby forming a second signal feeding point, wherein the first feed line 4′ and the second feed line 5′ are arranged in a cross manner on different sides of the circuit board 1.

If the first antenna 2 and the second antenna 3 are arranged on the same side of the circuit board 1, then in Step S106, a spacer 324 is first arranged on the inner triangular body 322 of the fourth radiator 32. Moreover, in this step, the insulating layer 52 of the second feed line 5 is arranged across the insulating layer 42 of the first feed line 4, and the outer conducting layer 53 of the second feed line 5 is electrically connected to the spacer 324, to be electrically connected to the fourth radiator 32 through the spacer 324, to form the second signal feeding point. Moreover, the first feed line 4 and the second feed line 5 are arranged in a cross manner on the same side of the circuit board 1. In one embodiment, a height of the spacer is between 0.5 mm and 1.5 mm.

It is worth mentioning that a length ratio of the central conductor 41 (41′), 51 (51′), the insulating layer 42 (42′), 52 (52′), and the outer conducting layer 43 (43′), 53 (53′) of each of the first feed line 4 (4′) and the second feed line 5 (5′) is 1:0.7:2. By adopting the above length ratio, the first feed line 4 (4′) and the second feed line 5 (5′) are matched with the crossed dipole antenna 10 (10′), thereby preventing the signal and gain attenuation during the signal transmission and reception.

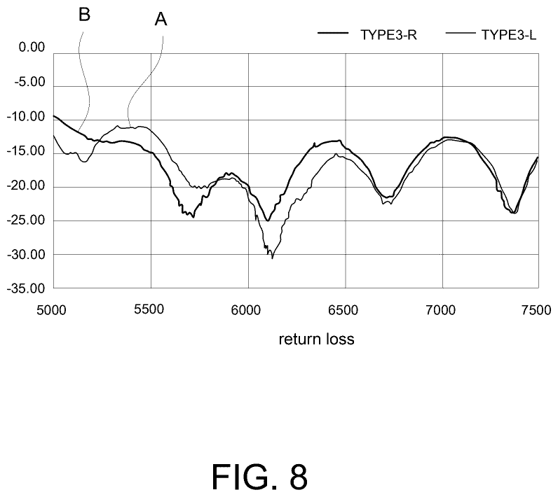

FIG. 8 shows a schematic diagram showing the crossed dipole return loss according to the present disclosure. In FIG. 8, the curve A represents the return loss values of the crossed dipole antenna 10 of the embodiment of the above FIG. 1 to FIG. 3. The curve B represents the return loss values of the crossed dipole antenna 10′ of another embodiment of the above FIG. 4 to FIG. 6.

The crossed dipole antenna 10 (10′) of the two embodiments may be applied in the high-frequency band (5925 MHz-7125 MHz), and may even cover a wide frequency range from 5150 MHz to 7125 MHz, encompassing from 5G to 6G. Therefore, after the first antenna 2 (2′) and the second antenna 3 (3′) of the crossed dipole antenna 10 (10′) are orthogonally arranged at a 90-degree angle, the return loss may be kept below −10 dB. For example, in the frequency band of 5500 MHz-5800 MHz, the return loss may reach −25 dB; in the high-frequency band of 6000 MHz-7000 MHz, the return loss may reach over −40 dB.

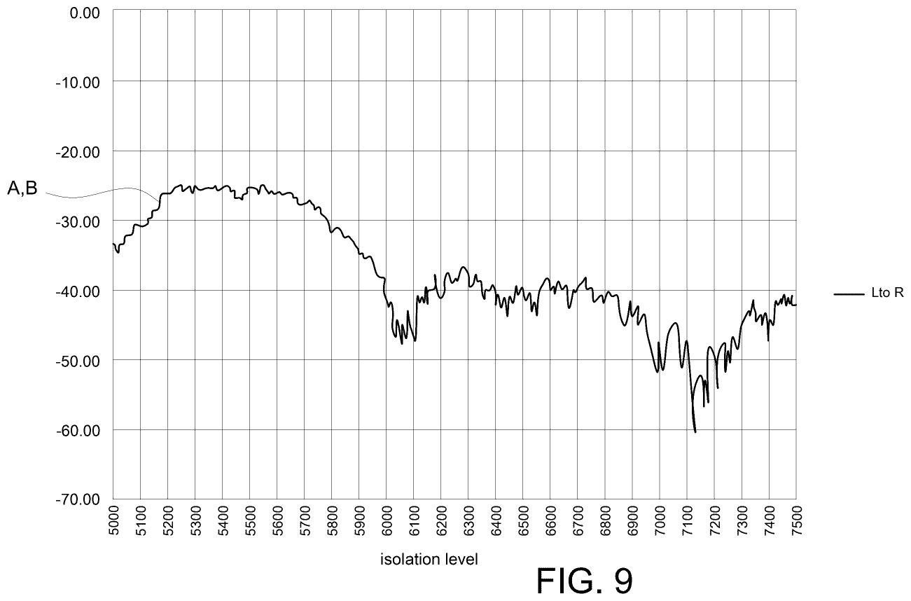

FIG. 9 shows a schematic diagram showing the crossed dipole isolation level according to the present disclosure. In FIG. 9, the curve A represents the isolation level of the crossed dipole antenna 10 of the embodiment of the above FIG. 1 to FIG. 3; the curve B represents the isolation level of the crossed dipole antenna 10′ of another embodiment of the above FIG. 4 to FIG. 6.

Due to the orthogonal 90-degree angle between the first antenna 2 and the second antenna 3 of the crossed dipole antenna 10, and the overlap at the positions of the insulating layers 42, 52, in the present disclosure, when the second feed line 5 is soldered, at least one spacer 324 (tin-based solder ball) is additionally arranged on the fourth radiator 32 to elevate the soldering point of the outer conducting layer 53 (braided wires) of the second feed line 5, thereby raising the positions of the insulating layer 52 (Teflon) and the outer conducting layer 53 of the second feed line 5 to a height within a distance range between 0.5 mm and 1.5 mm. By increasing the distance at the overlap of the first feed line 4 and the second feed line 5, the interference coefficient (isolation) may be significantly improved. Currently, the market requires the interference coefficient to be between −20 dB and −25 dB, but the antenna module of the present disclosure may raise the interference coefficient to above −30 dB for the entire frequency range. Since the high-frequency signals are very sensitive, increasing the distance mentioned above results in a significant improvement.

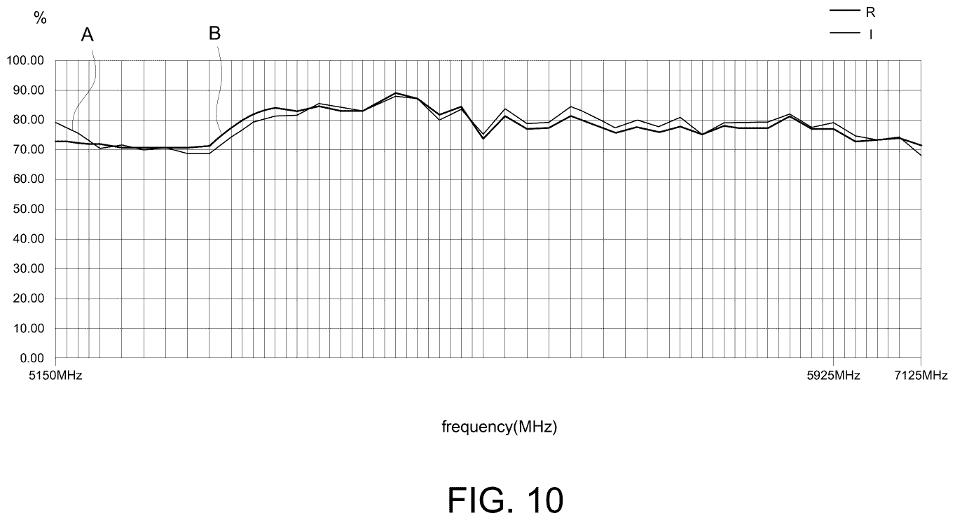

FIG. 10 shows a schematic diagram showing the efficiency of the crossed dipole antenna according to the present disclosure. In FIG. 10, the curve A represents the efficiency of the crossed dipole antenna 10 of the embodiment of the above FIG. 1 to FIG. 3; the curve B represents the efficiency of the crossed dipole antenna 10′ of the embodiment of the above FIG. 4 to FIG. 6.

In the present disclosure, the crossed dipole antennas 10, 10′ of the two embodiments may be applied in the high-frequency band (5925 MHz-7125 MHz), and may even cover a wide frequency range from 5150 MHz to 7125 MHz. Therefore, the efficiency of the crossed dipole antennas 10 and 10′ may reach between 70% and 80%, which is superior to the conventional dipole antenna, whose efficiency is typically around 60%.

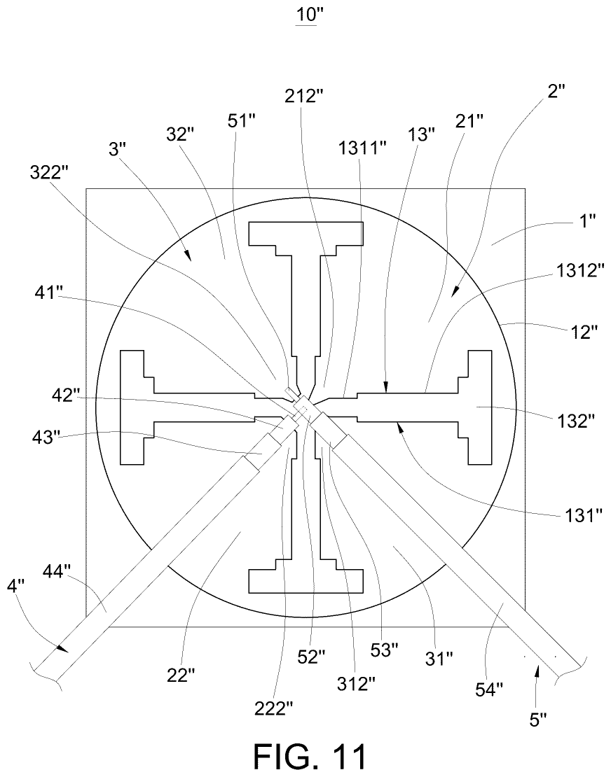

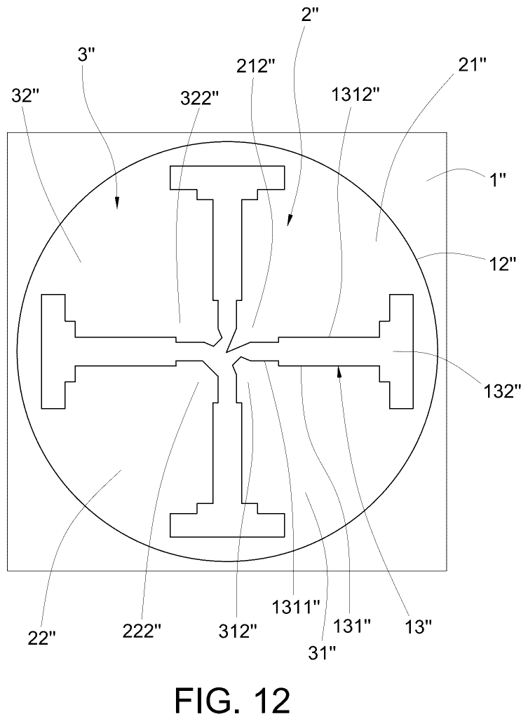

Please refer to FIG. 11 and FIG. 12. FIG. 11 shows a schematic appearance diagram of a crossed dipole antenna according to an embodiment of the present disclosure. FIG. 12 shows a schematic appearance diagram of the circuit board of the crossed dipole antenna of FIG. 11. FIG. 11 and FIG. 12 disclose a crossed dipole antenna 10″, which includes a circuit board 1″, a first antenna 2″, a second antenna 3″, a first feed line 4″, and a second feed line 5″. Moreover, the first antenna 2″ and the second antenna 3″ are arranged on the same side of the circuit board 1″, and the first antenna 2″ and the second antenna 3″ are electrically connected to the first feed line 4″ and the second feed line 5″, respectively, so as to form the crossed dipole antenna 10″. In one embodiment, the circuit board 1″ is a printed circuit board, and the crossed dipole antenna 10″ is a printed antenna structure.

On one side of the circuit board 1″, a circular metal layer 12″ is provided, and a cross-shaped slot (bare region) 13″ is formed on the circular metal layer 12″. The cross-shaped slot 13″ is used to divide the circular metal layer 12″ into a first radiator 21″, a second radiator 22″, a third radiator 31″, and a fourth radiator 32″. The first radiator 21″ and the second radiator 22″ are symmetrical to each other and are arranged in a straight line to form the first antenna 2″. The third radiator 31″ and the fourth radiator 32″ are symmetrical to each other and are arranged in a straight line to form the second antenna 3″. The second antenna 3″ and the first antenna 2″ are orthogonally arranged at 90 degrees on the same side. Arc-shaped end portions of the first radiator 21″, the second radiator 22″, the third radiator 31″, and the fourth radiator 32″ are electrically connected to each other, such that the cross-shaped slot 13″ is in a closed state.

The cross-shaped slot 13″ mentioned above includes four perpendicular line segments. Each of the four perpendicular line segments sequentially includes a straight segment 131″ and a geometric pattern 132″ extending outward from a center point of the circuit board 1″. The straight segment 131″ includes a thin line segment 1311″ and a thick line segment 1312″ connected to the thin line segment 1311″. The straight segment 131″ is further connected to the geometric pattern 132″ by the thick line segment 1312″. In this embodiment, the geometric pattern 132″ may be a polygon, a circle, or an ellipse, wherein the polygon includes a triangle, a square, a rectangle, a rhombus, a trapezoid, a pentagon, or a hexagon. In the embodiment of FIG. 11 and FIG. 12, the cross-shaped slot 13″ includes a first line segment, a second line segment, a third line segment, and a fourth line segment. The first line segment extends upward from the center point of the circuit board 1″. The second line segment is perpendicular to the first line segment and extends leftward from the center point of the circuit board 1″. The third line segment is perpendicular to the second line segment and extends downward from the center point of the circuit board 1″. The fourth line segment is perpendicular to the third line segment and the first line segment, and extends rightward from the center point of the circuit board 1″.

It is worth noting that the cross-shaped slot 13″ serves as a path for current flow when the crossed dipole antenna 10″ performs signal reception or transmission. Different shapes of the geometric pattern 132″ on the cross-shaped slot 13″ result in different current magnitudes. Moreover, by adjusting the length and width (thickness) of the straight segment 131″ of the cross-shaped slot 13″, the magnitude of the current flowing therethrough may be varied, while simultaneously causing the operating frequency band of the crossed dipole antenna 10″ to change, thereby facilitating adjustment of an optimal reception or transmission frequency band of the crossed dipole antenna 10″.

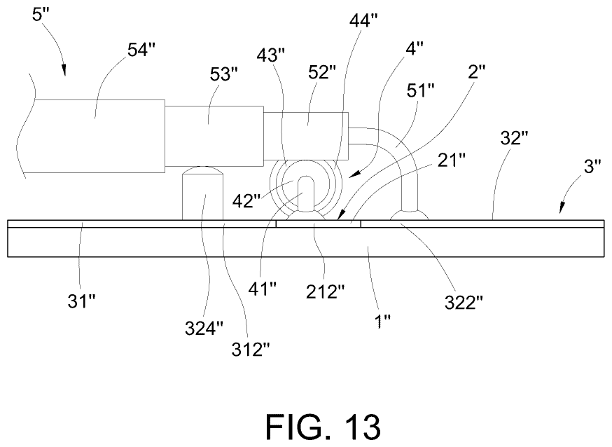

Continuing, please refer to FIG. 13. FIG. 13 shows a schematic side view of the circuit board of the crossed dipole antenna of FIG. 11 after being electrically connected to the first feed line and the second feed line, and reference is also made to FIGS. 11 and 12. The above-mentioned first feed line 4″ and second feed line 5″ may be made of the same wire materials. As shown in FIG. 11, the first feed line 4″ and the second feed line 5″ respectively include a central conductor 41″ and 51″. An insulating layer 42″ and 52″ respectively cover the surface of the central conductor 41″ and 51″. An outer conductor 43″ and 53″ respectively cover the surface of the insulating layers 42″ and 52″. A covering layer 44″ and 54″respectively cover the surface of the outer conductor 43″ and 53″.

Similarly, as shown in FIG. 11, the central conductor 41″ of the first feed line 4″ is electrically connected to an arrow-shaped first soldering body 212″ of the first radiator 21″, and the outer conductor 43″ of the first feed line 4″ is electrically connected to an arrow-shaped second soldering body 222″ of the second radiator 22″, thereby forming a first signal feeding point. Additionally, the central conductor 51″ of the second feed line 5″ is electrically connected to an arrow-shaped fourth soldering body 322″ of the fourth radiator 32″, and the outer conductor 53″ of the second feed line 5″ is electrically connected to an arrow-shaped third soldering body 312″ of the third radiator 31″, thereby forming a second signal feeding point.

It is noteworthy that, in the embodiment disclosed in FIG. 11, the first antenna 2″ and the second antenna 3″ are disposed on a same side of the circuit board 1″. When the first antenna 2″ and the second antenna 3″ are disposed on the same side of the circuit board 1″, as shown in FIG. 13, and when the second feed line 5″ is electrically connected to the second antenna 3″, a spacer 324″ may first be disposed on the third soldering body 312″ of the third radiator 31″. In this embodiment, the insulating layer 52″ of the second feed line 5″ is configured to cross over the insulating layer 42″ of the first feed line 4″, so that the outer conductor 53″ of the second feed line 5″ is electrically connected to the spacer 324″ and further electrically connected to the third radiator 31″ through the spacer 324″, thereby forming the second signal feeding point. The spacer 324″ of the present disclosure elevates the second feed line 5″ to electrically connect with the third radiator 31″ of the second antenna 3″. The primary function of the spacer 324″ mentioned above is to raise the second feed line 5″ and increase the distance between the second feed line 5″ and the signal plane, thereby improving the isolation of the antenna. In one embodiment, the spacer 324″ is a solder ball. In one embodiment, the height of the spacer 324″ is between 0.5 mm and 1.5 mm.

It is even more noteworthy that, in the present disclosure, the central conductors 41″, 51″, the insulating layers 42″, 52″, and the outer conductors 43″, 53″ of each of the first feed line 4″ and the second feed line 5″ have a length ratio of 1:0.7:2. By using the above length ratio, the first feed line 4″ and the second feed line 5″ are matched with the crossed dipole antenna 10″, so that during signal transmission and reception, neither the signal nor the gain is attenuated.

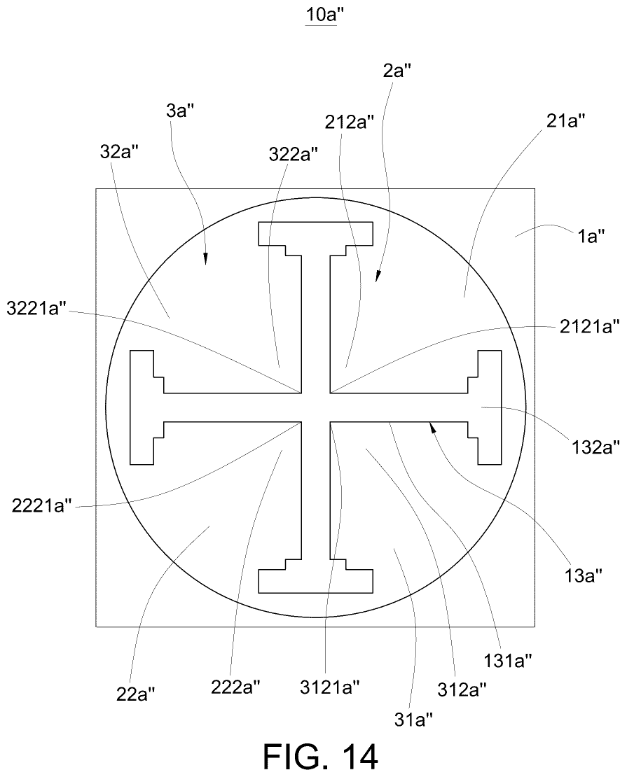

Please refer to FIG. 14, which is a schematic appearance diagram of the circuit board of the crossed dipole antenna according to an embodiment of the present disclosure. As shown in the figure, in this embodiment, the crossed dipole antenna 10a″ is generally similar to the crossed dipole antenna 10″ shown in FIGS. 11 to 13. The difference lies in that the shapes of the first radiator 21a″ and the second radiator 22a″ of the first antenna 2a″ and the third radiator 31a″ and the fourth radiator 32a″ of the second antenna 3a″ are further redesigned, with front ends of the arrow-shaped first soldering body 212a″ of the first radiator 21a″, the arrow-shaped second soldering body 222a″ of the second radiator 22a″, the third soldering body 312a″ of the third radiator 31a″, and the fourth soldering body 322a″ of the fourth radiator 32a″ designed as right-angled and formed at right angles 2121a″, 2221a″, 3121a″, and 3221a″, respectively.

After the front ends of the arrow-shaped first soldering body 212a″, the arrow-shaped second soldering body 222a″, the third soldering body 312a″, and the fourth soldering body 322a″ are designed as and formed at the right angles 2121a″, 2221a″, 3121a″, and 3221a″, respectively, the cross-shaped slot 13a″ includes four perpendicular line segments. Each of the four perpendicular line segments sequentially includes a straight segment 131a″ and a geometric pattern 132a″ extending outward from a center point of the circuit board 1a″. The straight segments 131a″ from an intersection point of the four perpendicular line segments to the geometric patterns 132a″ have same width. The geometric patterns 132a″ have same shapes.

By configuring the vacant spaces of the straight segments 131a″ on the cross-shaped slot 13a″ to be of equal width or equally spaced, the magnitude of the current passing through may be altered. At the same time, after the current magnitude is changed, the frequency band of the crossed dipole antenna 10a″ also changes accordingly, thereby facilitating the adjustment of the optimal reception or transmission frequency band of the crossed dipole antenna 10a″.

The above description is merely an exemplary embodiment of the present application and is not intended to limit the scope of the patent protection sought by this application. Therefore, any equivalent modifications or variations made using the contents of the specification or the drawings of this application are similarly included within the scope of the patent protection claimed in this application, as explicitly stated.

What is claimed is:

1. A crossed dipole antenna comprising:
a circuit board;
a first antenna, arranged on the circuit board, and comprising a first radiator and a second radiator linearly arranged;
a second antenna, arranged on the circuit board, and orthogonal to the first antenna at an angle of 90 degrees, and comprising a third radiator and a fourth radiator linearly arranged;
a first feed line, electrically connected to the first radiator and the second radiator; and
a second feed line, arranged across the first feed line, and electrically connected to the third radiator and the fourth radiator.

2. The crossed dipole antenna of the claim 1, wherein each of the first radiator, the second radiator, the third radiator, and the fourth radiator comprises a polygonal body, each of the polygonal bodies extends at two ends respectively with an inner triangular body and an outer triangular body symmetrical to each other, the two inner triangular bodies of the first radiator and the second radiator adjacent to each other are electrically connected to the first feed line, respectively, and the two inner triangular bodies of the third radiator and the fourth radiator adjacent to each other are electrically connected to the second feed line, respectively.

3. The crossed dipole antenna of the claim 2, wherein each of the first feed line and the second feed line comprises a central conductor, an insulating layer, an outer conducting layer, and a covering layer, wherein a surface of the central conductor is covered with the insulating layer, a surface of the insulating layer is covered with the outer conducting layer, and a surface of the outer conducting layer is covered with the covering layer, wherein the central conductor of the first feed line is electrically connected to the inner triangular body of the first radiator, and the outer conducting layer of the first feed line is electrically connected to the inner triangular body of the second radiator to form a first signal feeding point, wherein the central conductor of the second feed line is electrically connected to the inner triangular body of the third radiator, and the outer conducting layer of the second feed line is electrically connected to the inner triangular body of the fourth radiator to form a second signal feeding point.

4. The crossed dipole antenna of the claim 3, wherein a length ratio of the central conductor, the insulating layer, and the outer conducting layer of each of the first feed line and the second feed line is 1:0.7:2.

5. The crossed dipole antenna of the claim 3, wherein a coupling gap is between the inner triangular bodies of the first radiator, the second radiator, the third radiator, and the fourth radiator, respectively, and the coupling gap is between 0.1 mm to 0.5 mm.

6. The crossed dipole antenna of the claim 3, wherein the first radiator and the second radiator of the first antenna are arranged on one side of the circuit board, and the third radiator and the fourth radiator of the second antenna are arranged on other side of the circuit board.

7. The crossed dipole antenna of the claim 3, wherein the first radiator and the second radiator of the first antenna and the third radiator and the fourth radiator of the second antenna are arranged on a same side of the circuit board.

8. The crossed dipole antenna of the claim 7, further comprising a spacer arranged on the inner triangular body of the fourth radiator, wherein the insulating layer of the second feed line is arranged across the insulating layer of the first feed line, and the outer conducting layer of the second feed line is electrically connected to the spacer to be electrically connected to the fourth radiator through the spacer to form the second signal feeding point.

9. The crossed dipole antenna of the claim 8, wherein the spacer is a solder ball with a height between 0.5 mm and 1.5 mm.

10. The crossed dipole antenna of the claim 1, wherein a circular metal layer is disposed on one side of the circuit board, a cross-shaped slot is formed on the circular metal layer, and the cross-shaped slot is configured to divide the circular metal layer into the first radiator, the second radiator, the third radiator, and the fourth radiator, wherein the first radiator and the second radiator are configured to constitute the first antenna, and the third radiator and the fourth radiator are configured to constitute the second antenna, and wherein ends of the first radiator, the second radiator, the third radiator, and the fourth radiator are electrically connected together, and the cross-shaped slot is in a closed state.

11. The crossed dipole antenna of the claim 10, wherein the cross-shaped slot comprises four perpendicular line segments, each of the four perpendicular line segments sequentially comprises a straight segment and a geometric pattern extending outward from a center point of the circuit board, the straight segment comprises a thin line segment and a thick line segment connected to the thin line segment, and the straight segment is connected to the geometric pattern by the thick line segment.

12. The crossed dipole antenna of the claim 11, wherein the geometric pattern comprises a polygon, a circle, or an ellipse, wherein the polygon comprises a triangle, a square, a rectangle, a rhombus, a trapezoid, a pentagon, or a hexagon.

13. The crossed dipole antenna of the claim 12, wherein the first feed line and the second feed line are made of same wire materials, each of the first feed line and the second feed line comprises a central conductor, an insulating layer covers a surface of the central conductor, an outer conductor covers a surface of the insulating layer, a covering layer covers a surface of the outer conductor, and the central conductor, the insulating layer, and the outer conductor of each of the first feed line and the second feed line have a length ratio of 1:0.7:2.

14. The crossed dipole antenna of the claim 13, wherein the central conductor of the first feed line is electrically connected to an arrow-shaped first soldering body of the first radiator, and the outer conductor of the first feed line is electrically connected to an arrow-shaped second soldering body of the second radiator, thereby forming a first signal feeding point, and the central conductor of the second feed line is electrically connected to an arrow-shaped fourth soldering body of the fourth radiator, and the outer conductor of the second feed line is electrically connected to an arrow-shaped third soldering body of the third radiator, thereby forming a second signal feeding point.

15. The crossed dipole antenna of the claim 14, wherein the first antenna and the second antenna are disposed on a same side of the circuit board, a spacer is disposed on the arrow-shaped third soldering body of the third radiator, and the insulating layer of the second feed line is configured to cross over the insulating layer of the first feed line, so that the outer conductor of the second feed line is electrically connected to the spacer and electrically connected to the third radiator through the spacer, thereby forming the second signal feeding point.

16. The crossed dipole antenna of the claim 15, wherein the spacer is a solder ball with a height between 0.5 mm and 1.5 mm.

17. The crossed dipole antenna of the claim 14, wherein front ends of the arrow-shaped first soldering body of the first radiator, the arrow-shaped second soldering body of the second radiator, the arrow-shaped third soldering body of the third radiator, and the arrow-shaped fourth soldering body of the fourth radiator are right-angled.

18. The crossed dipole antenna of the claim 17, wherein the straight segments from an intersection point of the four perpendicular line segments to the geometric patterns have same width.

19. The crossed dipole antenna of the claim 17, wherein the geometric patterns have same shapes.
